(19) United States
(12) Patent Application Publication
(10) Pub. No.: US 2014/0040016 A1
(43) Pub. Date: Feb. 6, 2014

(54) REAL-TIME TARGETED DYNAMIC ADVERTISING IN MOVING VEHICLES

(71) Applicants: Vanya Amla, Brookline, MA (US); Christian Joly, San Jose, CA (US)

(72) Inventors: Vanya Amla, Brookline, MA (US); Christian Joly, San Jose, CA (US)

(21) Appl. No.: 13/566,929

(22) Filed: Aug. 3, 2012

(51) Int. Cl. G06Q 30/02

(52) U.S. Cl. 705/14.45; 705/14.63; 705/14.46; 705/14.41

(57) ABSTRACT

Dynamically changing targeted advertising content is dispatched wirelessly in real time via a cellular network from a remote web portal to a plurality of vehicles, and ads are displayed on a digital display mounted in a rear window of the vehicles. Vehicles communicate wirelessly to the web portal their geographic location, and cameras are used to record the effect of the ads on viewers in following vehicles. Ads are changed based upon criteria established by advertisers, changing vehicle geographic locations, and changing conditions such as areas, times of day, traffic on roads, and profiles of viewers.

### BACKGROUND

This invention relates generally to the real-time display of dynamic content in moving vehicles, and more particularly to a method and system for dynamically creating, distributing and displaying content such as targeted advertising in a moving vehicle.

Location based services for mobile devices such as cell phones that assist users in finding points of interest such as a store or a restaurant or for tracking friends in the immediate vicinity of the user are known. Advertisers have used location information from such mobile devices to target advertisements (“ads”) to the devices based on users' searches or their indicated interests, as in the case of social media. The goal is to provide timely relevant ads to people based on what they are seeking. Most of the algorithms used for such targeted advertising start with a search word as the seed and display target ads that are relevant to that word. For example, if a person is searching for a restaurant, ads for restaurants in the person's local area may be displayed. However, the algorithms do not target ads to people who are not actively searching, who may not know that what they need is in the vicinity, or impulse buyers of things they had not thought of purchasing. For example, if a person were near a theater and tickets were on sale for a current production, relevant advertising could spark interest and drive people to the theater. However, unless a person was searching for something relevant to the theater or the production, ads would not be targeted to the person. Similarly, most people in vehicles may be unaware that they are in the vicinity of a particular business unless it is brought to their attention. Based on the time of day, the traffic conditions on the roads, etc., it is possible to predict what may interest someone. For example, if there is usually a traffic jam at certain times of the day a close-by restaurant might like to advertise its presence to solicit business. Displaying an ad indicating a close proximity to the restaurant and offering a discount, for instance, could drive incremental business to the restaurant. Mobile device advertising applications do not satisfactorily address these problems.

Outdoor advertising on vehicles is also known. Static ads displayed on busses, taxicabs, delivery vehicles, etc., are common, but they have limited effectiveness. They primarily target people walking on sidewalks and in passing vehicles, and have the advantage of not requiring a target of the ad to be actively using a mobile device. However, vehicle ads are not easily changed so they are not adaptable to changing conditions, and are not well suited for text messages due to the limited time available (typically about three seconds) to read them. Vehicle displays are also expensive, require manual installation and updating, and usually require an ad to run for a minimum amount of time, e.g., 3 to 6 months. Such ads are not well suited to local businesses that may have a small budget and would like to target advertising to people traveling in their vicinity without committing themselves to a long advertising campaign. Local businesses do not have an easy and cost effective method to target a local audience. Moreover, static ads do not effectively address the need to target local areas, different profiles of people on the roads at different times, or different conditions. Finally, one of the major drawbacks of advertising in vehicles is the lack of a measurement effective to enable advertisers to understand the influence and reach of their advertising campaigns or to determine their effect.

It is desirable to provide systems and methods which address the foregoing and other problems of know advertising approaches by afford real-time targeted dynamic advertising, and it is to these ends that the present invention is directed.

### SUMMARY OF THE INVENTION

In one aspect, the invention affords an intelligent method and system for dynamically distributing and displaying content on digital display panels mounted in a moving vehicle, where the content is dynamically selected and changed based upon vehicle geographic position and predetermined criteria.

In a more specific aspect, the content comprises advertisements which are selected based upon changing conditions including one or more of the direction and speed of the vehicle, the time of day, vehicle type, number of vehicle displays, profile of the population in the vicinity of the vehicle, and current events and conditions. The display panels are preferably mounted in the rear windshield of the vehicle for viewing by occupants in vehicles behind the displaying vehicle.

In another aspect, the advertisements are delivered dynamically and wirelessly via a cellular wireless communications link to the vehicle. In a further aspect, the advertisements may be stored locally in the vehicle for display in accordance with the changing conditions and factors.

The invention further affords a web portal that interfaces with vehicle owners, advertisers and the targeted audience, and provides an analytics module to help advertisers understand the effectiveness of their advertising campaigns and the costing structure based upon factors such as the geographic area in which the vehicle is driven and the amount of time a particular advertisement is displayed. Since the vehicles constantly provide feedback about their location, speed and direction to the web portal server, this information can be used to provide more accurate costing for an advertising campaign. The web portal allows vehicle owners to register their vehicles and create personal accounts. This allows owners to check their accounts to determine how much money was earned based upon the amount of time driven, the times a day, and traffic on the road at those times. It also allows owners to choose a category of ads that can be displayed or not on their vehicle, and provides statistical information to owners about their driving habits.

Advertisers can create their ads, choose the areas they would like to target, the days and times of the ads, and the number of vehicles/displays desired. The cost of the ad campaign based upon the selected criteria can be shown instantaneously so the advertisers can make modifications based on their budgets. Advertisers also have access to analysis tools to assist them in understanding the effectiveness of their ad campaigns.

Finally, the target audience that views advertisements on the displays can use the web page to find ads of interest that they saw. Using a location, road and time they can locate an ad or use a search engine to search for an ad of interest using keywords. As an incentive to the target audience to view ads on the portal, advertisers may provide coupons which can be downloaded and redeemed.

### BRIEF DESCRIPTION OF THE DRAWINGS

FIG. 1 is a block diagram illustrating an overview of a system in accordance with the invention for real-time creation, dispatching and display of advertisements.

FIG. 2A is a block diagram of a vehicle display module in accordance with the invention;

FIG. 2B illustrates a display panel adapted to be removably mounted to a vehicle window;

FIG. 3 is a diagrammatic view that gives an overview of the operation of the system of FIG. 1;

FIG. 4 is a flowchart of a process for dispatching advertisements to vehicles in accordance with an embodiment of the invention;

FIG. 5 is a block diagram illustrating a process for selecting advertisements in accordance with an embodiment of the invention;

FIG. 6 is a flowchart illustrating the operation of the costing and auction module in accordance with the invention; and

FIG. 7 is a flowchart illustrating a process for determining analytics in accordance with the invention.

### DESCRIPTION OF PREFERRED EMBODIMENTS

The invention is particularly well adapted for displaying real-time targeted dynamic advertising in moving vehicles and will be described in that context. It will be appreciated, however, that this is illustrative of only one utility of the invention and that the invention may be employed for displaying other types of dynamic content.

As will be described in more detail below, the invention affords a system and method for dynamically creating, dispatching and displaying targeted advertising content on moving vehicles based upon changing conditions and factors which include vehicle geographic location, direction and speed of travel, time of day, day of the week, the profile (demographics) of the population in the vicinity of the vehicle in an area, and current events and conditions, to name a few. The advertising content may be textual or graphical, and is preferably displayed on a digital display mounted on the rear windshield of the vehicles for external viewing by vehicles behind the vehicle having the display. A geographic area may be partitioned into different zones based upon demographic data, profiles of drivers at a given time of day, customer data, and places of interest. Ads may also be displayed based upon an analysis of the habits and interests of people on the roads in particular locations and at particular times. Using such information, the invention may predict the places or products of interest to the audience and dynamically target ads to vehicles in a particular area or zone. The invention, as will be described, may also track the impressions generated by advertisements on following vehicles to produce a measurement which may be provided back to advertisers to enable them to understand the effectiveness of their advertisements and enable them to change the focus of their advertising campaigns. This may be used in a process for pricing of ads in accordance with the area covered by a vehicle, the time of day, event and traffic on the roads, the time the ad is displayed, vehicle speed, and other such changing conditions and factors. The invention may also provide an auction system that allows advertisers to bid for the opportunity to reach a target audience with their ads at selected locations, selected times, and under selected circumstances. This allows advertisers to establish their own individual criteria to selectively target their ads based upon their target markets and advertising budgets, while allowing the advertising display provider to maximize advertising revenue by dynamically dispatching ads for display to different vehicles.

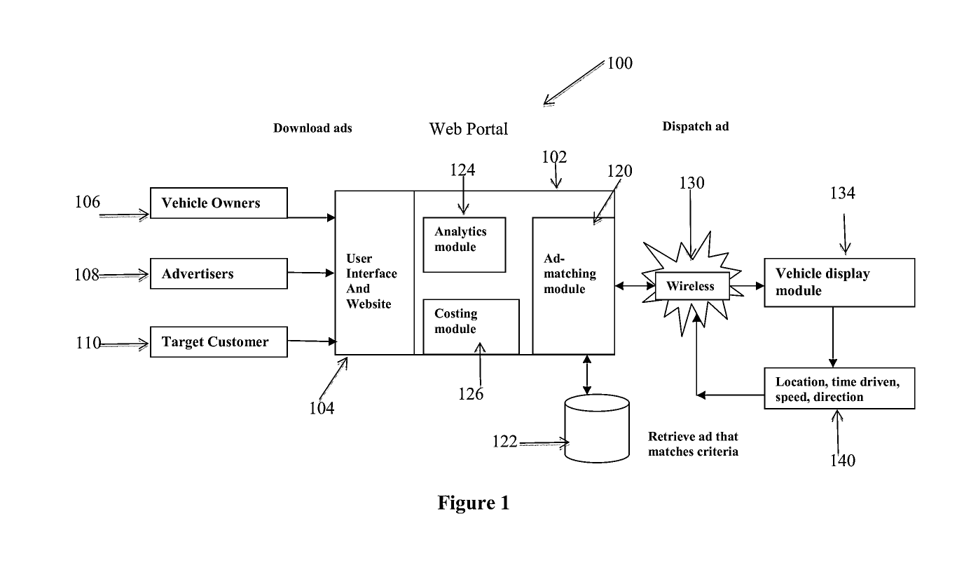

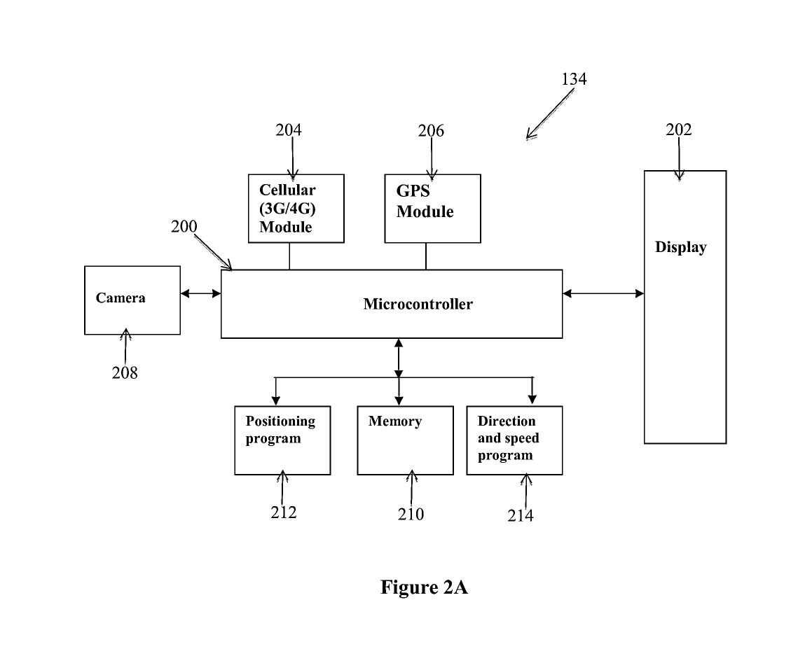

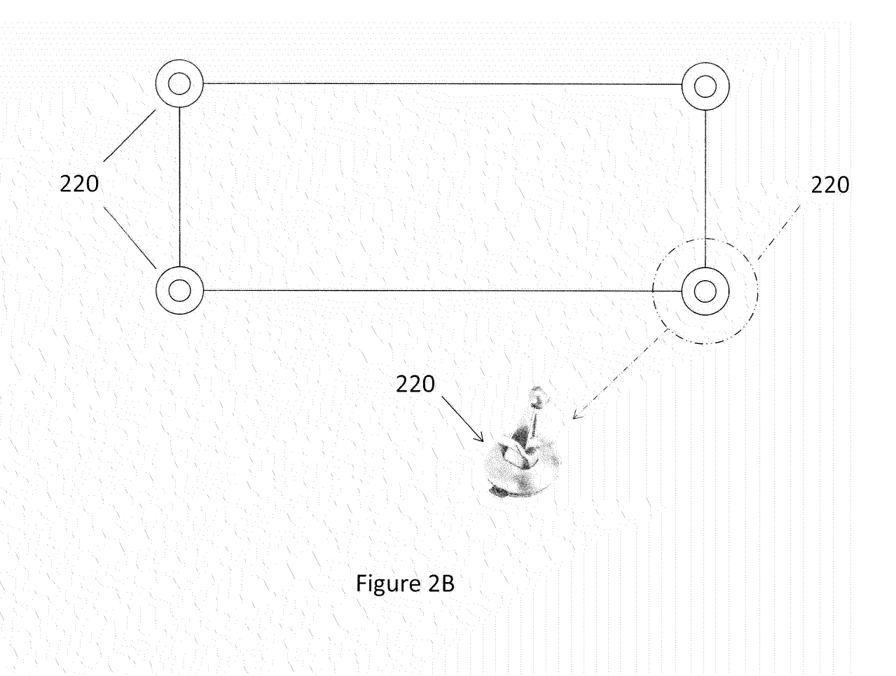

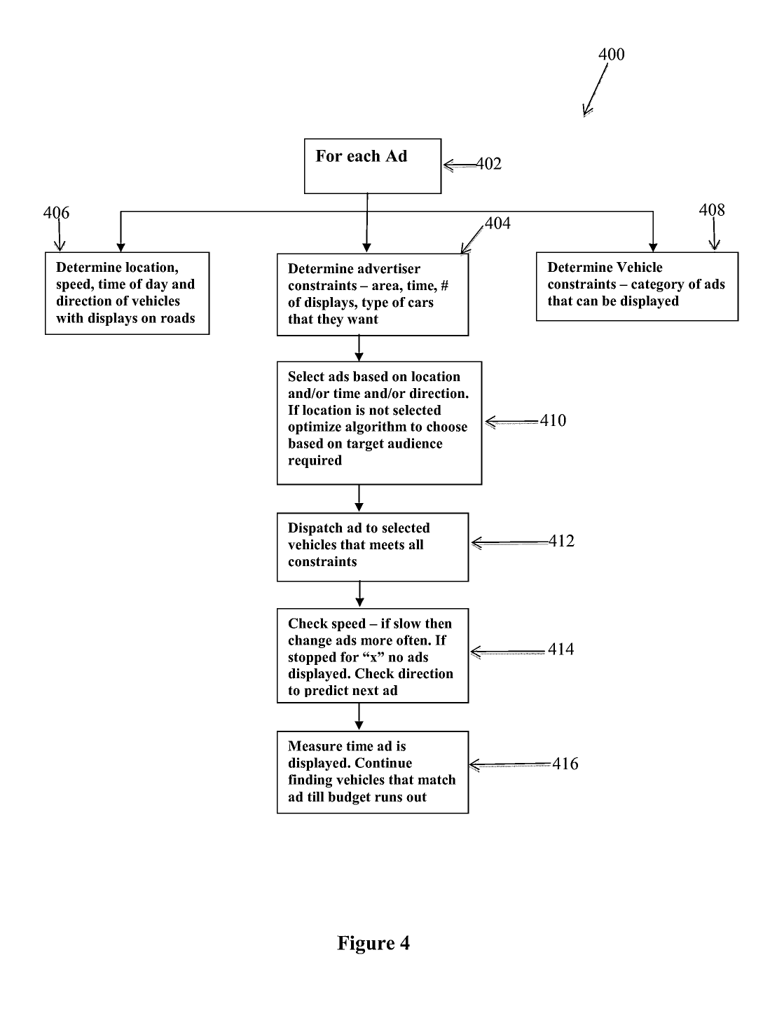

FIG. 1 is a block diagram of a system 100 in accordance with an embodiment of the invention for creating, dispatching, and dynamically displaying targeted advertisements in moving vehicles in real time based upon actual changing conditions and factors. As shown, the system may comprise a web portal (server) 102 that provides a website and user web interface 104 for vehicle owners 106, advertisers 108 and target customers 110. The web portal may further comprise an ad matching module 120 that selects advertisements to be displayed from database storage 122, an analytics module 124 which analyzes the impressions created by an ad on a targeted entity or to predict the impressions likely to be created, and a costing module 126 that may be used for pricing and charging for advertisements. The operations of the ad matching module, the costing module, and the analytics module will be described in more detail below in connection with FIGS. 4-7. Web portal 102 may communicate via a wireless cellular network 130 with one or more vehicles each having a vehicle display module 134 to displays ads dispatched by the web portal. The vehicle display module is shown in more detail in FIG. 2. As will be described, the vehicle display module may supply real-time vehicle data 140, such as geographic location, time, speed and direction of travel, back to the web portal via the wireless network 130. Ad matching algorithms in the ad matching module 120 may use such data as well as information on population profiles, demographics, traffic density information and advertisers criteria, etc., stored in database 122 to determine in real time what ads to display. The algorithms may also enable prediction of the most relevant ads to display in order to ensure maximum exposure and effect, as will be described. As a vehicle moves between geographic regions, the ads displayed may dynamically change in real-time based upon the changing conditions and predefined criteria, as will be described in more detail.

The web interface 104 allows information to be exchanged with any Internet connected device, such as a personal computer, a cell phone, laptop, etc. It may allow vehicle owners 106 to register their vehicles, establish accounts, and log onto their accounts. Once a vehicle is registered and the vehicle display module 134 is connected, owners can start earning money as they drive. A website account page for each vehicle owner allows the owner to view his account to see how much money was earned during a preceding time period, e.g., a day or a month. The web portal may also permit vehicle owners to choose one or more categories of ads that can be displayed (or not displayed), and provide statistical information about their driving habits. Depending on the areas, amount of time driven, times of day, traffic on the roads at those times, and other conditions and factors, the owners may earn and be paid based upon weightings established by different advertisers for the various factors.

Advertisers 108 may interface with the web portal to create or change an ad or ad campaign, choose the geographic areas (locations) they would like to target, the days and times ads are displayed, and the number of vehicles displaying their ads. The cost of ad campaigns may be shown instantaneously via the website so that advertisers can make modifications, as desired. Advertisers may also have access to the analysis tools of the analytics module 124, to be described, to assist them in understanding the effectiveness of their campaigns.

Additionally, the interface 104 may permit target customers who viewed displayed advertisements to use the web site to locate ads that they saw and about which they may like more information. Using keys such as the location, road, day and time, or a search engine to which they can provide keywords, customers may advantageously locate and review an ad of interest. They may also obtain additional information from the advertiser on the web site, or download redeemable coupons.

FIGS. 2A and 2B illustrate embodiments of a vehicle display module 134 and display panel 202 in accordance with the invention. The vehicle display module may have a microcontroller or microprocessor 200 which controls components of the vehicle display module and the digital display 202 for displaying advertisements, a cellular telephone module 204 that connects to a wireless network 134 for communicating with the web portal 102, a GPS module 206 that continuously tracks and reports the geographic location of the vehicle, and a camera 208 for collecting information such as the profiles of viewers of the advertisements, the impressions made by the advertisements, traffic conditions, and the characteristics of the areas through which the vehicle is driving. The microcontroller 200 may further have a memory 210 for storing advertisements and data collected, and memories 212 and 214 for respectively storing a positioning program and a direction and speed program for determining time, geographic location, and the direction and speed of travel of the vehicle to enable advertisements to be dynamically displayed based upon such factors.

The digital display 202 preferably comprises a high brightness flexible LCD or LED display panel with antiglare characteristics for outdoor applications to afford good viewing during the day or at night. The display panel is preferably adapted to be removably mounted to the interior of a window, such as the rear window, of a vehicle to display advertisements or other content to occupants of other vehicles or to others in the vicinity of the vehicle display. High brightness flexible LED panel displays suitable for use with the invention are available from, for example, Shenzhen Led-Hero Electronic Technology, Co. Ltd of Guangdong, China. A flexible display panel is preferable because it enables the panel to be contoured to different vehicle rear windows. The display panel may mount to the window using a known-type of pivotal level actuated suction cups 220 to accommodate different angles, or by using adhesives. The advantages of mounting a display panel within the rear window of the vehicle are that it can be easily positioned to facilitate viewing by following vehicles, such as at the top of the rear window, without unduly obstructing the rear view of the vehicle driver, is protected from damage or theft, and can be easily uninstalled and moved to another vehicle. Moreover, a rear facing display in accordance with the invention affords a longer viewing time, of the order of seven or more seconds, on average, than conventional vehicle mounted displays which typically have a viewing time of less than three seconds and are generally restricted to images with little or no text.

Camera 208 may be a low resolution lightweight digital camera that is also positioned at or mounted to the rear window of the vehicle. It may be separate from or integral with the display panel, and can be used to track the eyes of people in following vehicles to determine whether they are, in fact, viewing the displayed advertisement and for how long they viewed it, to determine the number of viewers who saw the advertisement, and for recording the characteristics of viewers to create profiles of the population of people on the roads. The data collected by the camera and by the GPS module 206 may be transmitted in real time back to the web portal by the cellular module 204 as well stored in memory 210. The real time data may be used for dynamically selecting and displayed ads in real time according to predetermined criteria so that ads may be changed frequently as conditions change, viewers change, and locations change. This enables advertisers to plan their ads to maximize their exposure to target markets and consumers at lower costs since they only need to pay for ads displayed at particular times or in particular geographic areas. It also provides data that allows the advertising portal owner to price ads based on viewing times and locations, so that pricing may be adjusted accordingly to maximize its revenue.

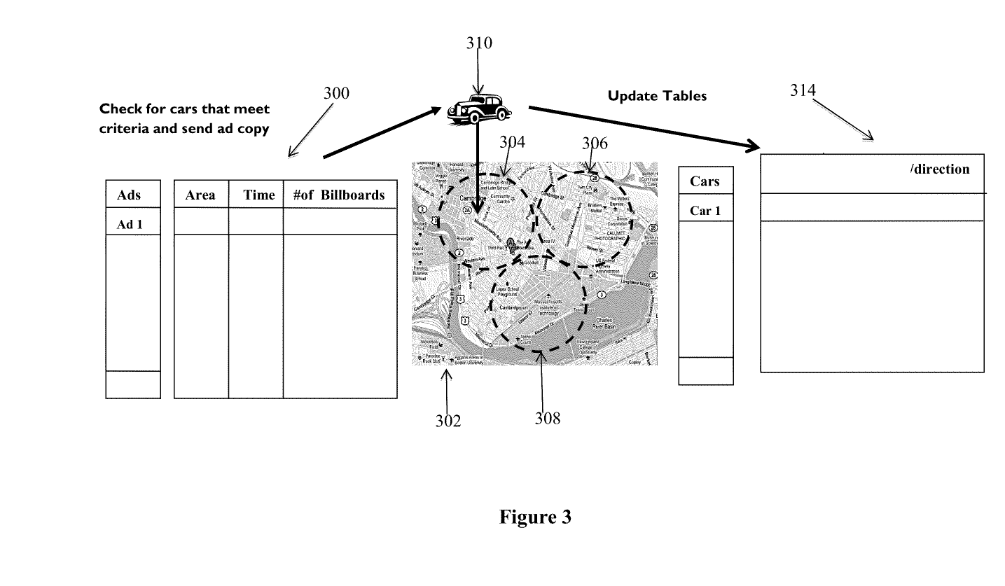

FIG. 3 illustrates diagrammatically the operation of the system to dynamically track vehicles and display ads. Criteria may be established and stored in a table 300 in the web portal that designates particular ads, such as “Ad 1”, that are to be displayed by Area, Time, and the number (“#”) of Billboards, i.e., vehicles. A geographic area 302 may be subdivided into a plurality of zones 304-308, as indicated in the figure, and this information may also be stored in the web portal. As a vehicle 310 drives within geographic area 302, the GPS module 150 tracks the location of the vehicle and the vehicle display module calculates the position, direction and speed of travel and transmit this data via the cellular module 154 back to the web portal which may store the data in a table 314. Table 314 is essentially a record of the route each vehicle drove that indicates the locations, zones and speed and direction of travel. As a vehicle drives its route, the web portal uses the criteria data in table 300, the current route data in table 304, and algorithms in the ad matching module 120 of the web portal to dispatch ads dynamically in real time to the vehicle for display. The web portal maintains data on each vehicle, the routes the vehicle drove, the times, the geographic areas through which the vehicle drove, and the ads displayed. This data may be used for billing an advertiser. It may also be made available on the web portal for viewing by both advertisers as well as vehicle owners so that they may each determine their respective advertising costs and compensation for displaying ads.

FIG. 4 illustrates an embodiment of an ad dispatching process 400 in accordance with the invention that may be incorporated into the ad matching module 120 of the web portal. Process 400 employs criteria that is established for an ad and real-time data provided by a vehicle to select and dispatch the ad to one or more vehicles for display. For each ad 402, process 400 determines at 404 the advertiser constraints such as area, time number of displays and types of cars that they want to display their ads. The process also determines at 406 for each vehicle on the road with a display, its location, speed, the time of day, and direction of travel, and determines at 408 the vehicle constraints as to the categories of ads that can be displayed. At 410, the process may select ads for display based on factors such as location, time, and direction of travel, or if location is not selected, ads may be chosen by an algorithm based upon target audience criteria established by the advertiser. At 412, ads are dispatched to vehicles that meet the predefined criteria and constraints. Using the real time data for each vehicle, at 414 the process checks to determine vehicle speed and direction. If the speed is low, the process may change ads more frequently. If the vehicle is stopped for longer than a certain period of time, no ads may be displayed. Based upon vehicle direction, the process may then select the next ad to be displayed. Finally, at 416 the process may measure the time each ad is displayed and continue to attempt to locate vehicles that match ad criteria based upon the advertiser's established budget.

As previously described, advertisers may create their own ads, and establish the criteria and constraints for their ad campaigns. They may choose, for example, the areas that they wish to target, the days and times of the ad campaign, the number of vehicles or displays they want, and other such factors. Since vehicles continuously provide feedback to the web portal in real time about their geographic location, speed and direction of travel, the invention uses this information in combination with advertisers' criteria and constraints in an ad matching and selection algorithm (described below) that may match ads to the most relevant displays to ensure maximum exposure. As vehicles enter a geographic region at a specific time, ads may change based upon the location of a targeted retail establishment, local events, or a profile of the local population. The frequency at which ads change may be determined by the speed of a vehicle and its location. If the vehicle is traveling at a slow speed or is stopped momentarily, such as a traffic jam, then the ads displayed by the vehicle may be changed more frequently or halted. Furthermore, using the knowledge of the kinds of people traveling on the roads in a particular area and a particular day or time, the system may predict the places or products likely to be of greatest interest to the target audience and uses information to select ads for display.

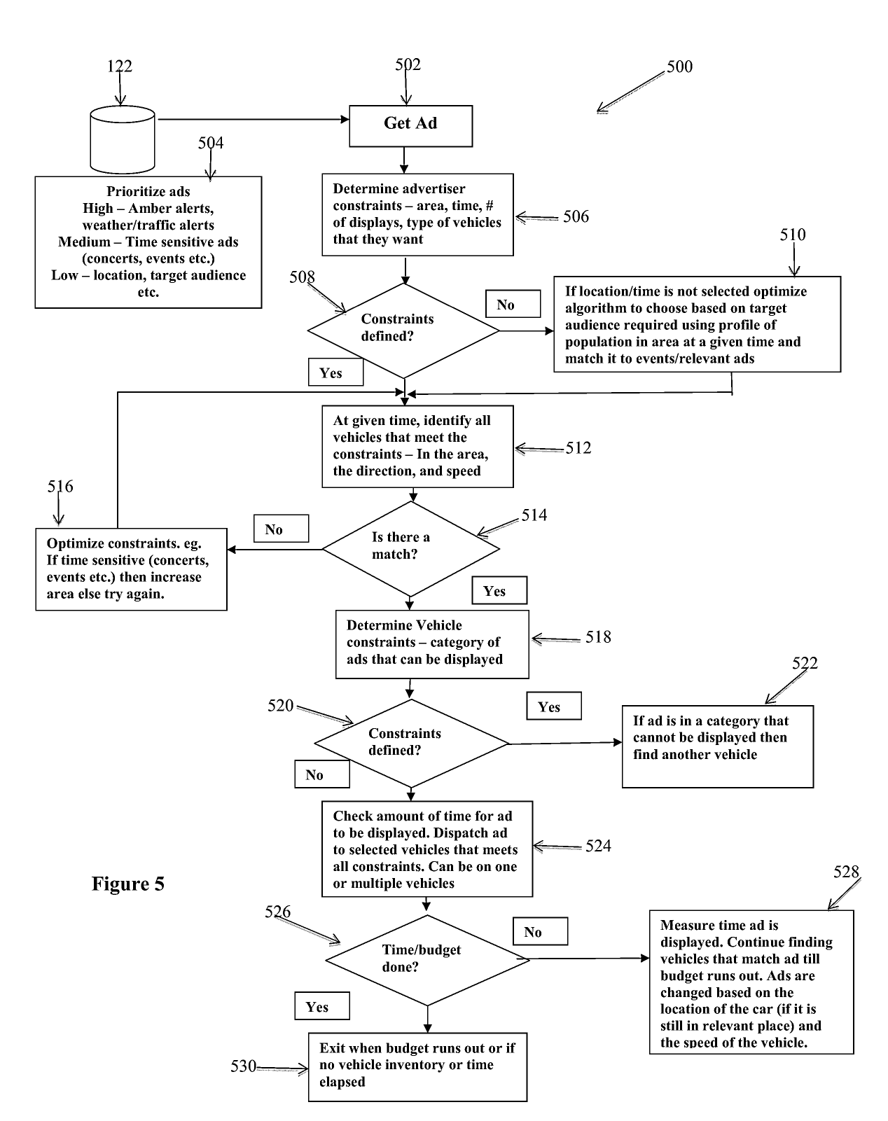

FIG. 5 illustrates an ad selection and matching process 500 in accordance with an embodiment of the invention. It embodies an algorithm that optimizes ad (or other content) selection for display based upon predetermined criteria, such as described above, and other dynamically changing factors and conditions. As previously described, database 122 of the web portal may store ads and other information to include display criteria, as well as other content, and that may be used for optimizing the selection of and content for display.

As indicated in the figure at 504, ads and content stored in database 122 may be prioritized as “high”, “medium”, or “low”. High-priority ads and content may be determined by factors such as Amber alerts, weather and traffic alerts. Ads of medium priority may be ads that are time sensitive, for example, ads related to current events such as concerts, and the like. Ads may be classified as low priority based upon factors such as location, target audience, and the like. At 506, the process determines whether there are advertiser constraints for an ad such as area, time or number of displays, or types of vehicles that are to be used, etc., to display an ad. If at 508 it is determined there are no constraints defined, at 510 ad selection may be optimized using an algorithm that selects ads based upon constraints such as target audience, a profile of the population in a particular area at a given time, or other changing factors such as matches to events. If, at 508 constraints are defined, or based upon constraints from the ad selection optimization algorithm at 510, at 512 all vehicles that meet the constraints at a given time, are in a particular area, and are traveling in the appropriate direction and speed are identified. If a vehicle match is not identified at 514, the selection criteria may be optimized again at 516 for events that are time sensitive or the target display area may be increased, and the process loops back to step 512 to attempt to identify a vehicle match.

If a match is identified at 514, dated 518 the process determines whether an identified vehicle has constraints as to the category of ad that can be displayed. At 520, if constraints are identified, at 522 the process determines whether a selected ad is in a category that may not be displayed by the vehicle. If so, the process then loops back to step 518 to find another vehicle and steps 520 and 522 repeat. If at 520 no constraints are defined, at 524 the advertiser's criteria and constraints are checked as to the amount of time the ad is to be displayed, and the ad is dispatched for display to one or more vehicles that meet the constraints.

At 526, a check is performed to determine whether an advertiser's time and budget for a displayed ad is completed. If not, at 528, the time that the ad was actually displayed is measured, and the process may repeat by continuing to locate vehicles that match the advertiser criteria to further display the ad until the budget runs out. Otherwise, at 530 the process exits when the advertising budget is consumed, no vehicle is available to display the ad, or the time allocated for the ad has elapsed.

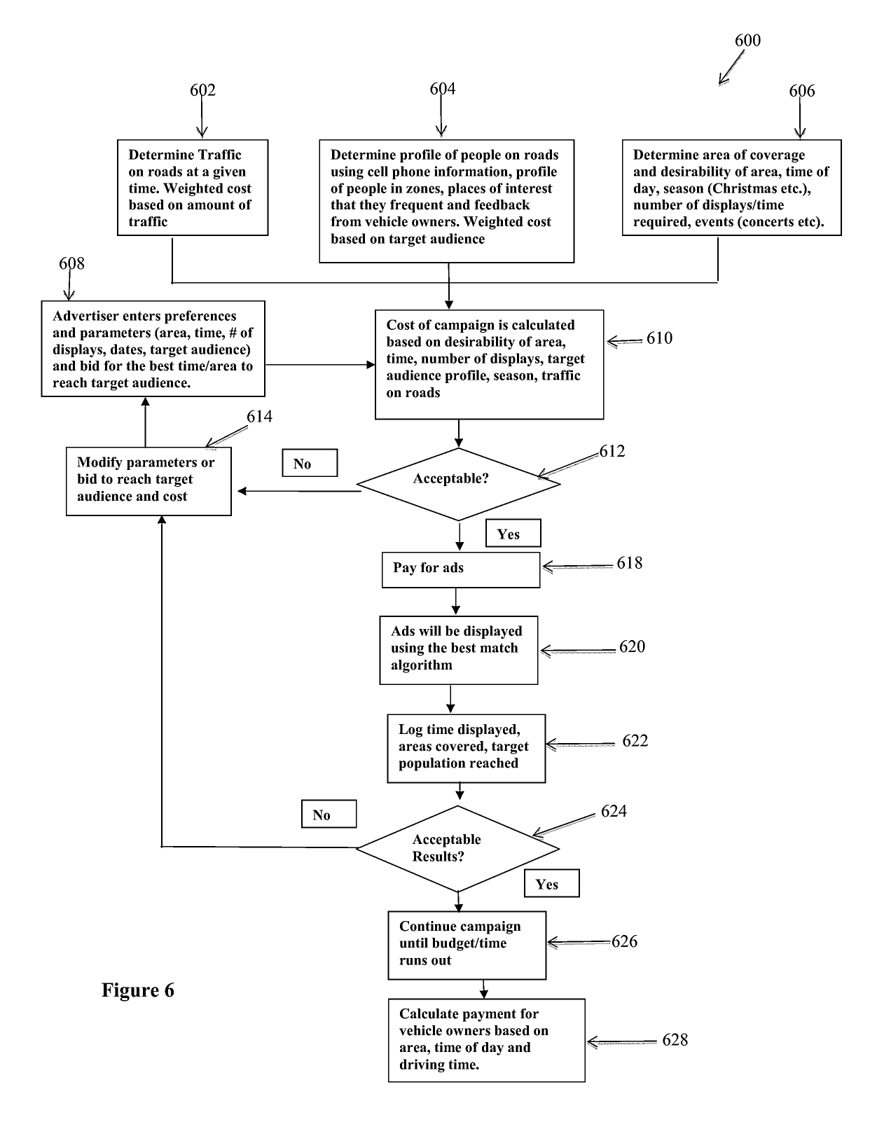

FIG. 6 illustrates an embodiment of a costing (pricing) process 600 in accordance with the invention that may be embodied in the costing module 126 of the web portal. Process 600 may include an interactive process component, as shown, that permits advertisers to plan an advertising campaign, establish advertising criteria and constraints for ads, and determine immediately what the cost of the campaign will be. This permits the advertisers to establish an advertising budget, and adjust the advertising criteria and constraints of their ad campaign to achieve a desired exposure within the established advertising budget. Advertisers may also use the process to refine an ad campaigns based upon the impressions created by the ads on their target audience. The costs of ad campaigns may be based upon different factors such as the area of coverage and the desirability of the area, the number of displays targeted, the number of days of the campaign, the time of the day and days of the week, types of events around the area of coverage on the days and times selected, and profiles of the people around the area of coverage on the days and times selected.

As shown in FIG. 6 at 602, the traffic on the roads at the time an ad is displayed may be determined and the weighted cost of the ad may be based upon the amount of traffic. The weighted cost may also be based upon the profile of the target audience, which may be determined (at 604) using cell phone information, profile information for people in the zones, places of interest, and feedback from vehicle owners. At 606, for a particular area of coverage, the desirability of the area, the time of day, a particular season of the year and the number of displays and times of the displays can be input into the process. At 608, the invention affords an auction process in which an advertiser may enter preferences and parameters for a desired advertising campaign, and bid for the best time or area to reach a target audience. Based upon the bids and the real time data, the display provider (web portal) may select ads for display by a plurality of different vehicles based upon the bids. At 610 the cost the campaign may be calculated based upon the input from the advertiser and information from steps 602-606 and presented to the advertiser. If at 612 the cost is not acceptable, the process may branch 614 where the advertiser may modify the parameters of a advertising campaign to adjust the cost, and the process steps 608 and 610 repeat. Once the advertiser accepts the costs, he may pay for the advertising campaign at 618.

Subsequently, at 620 ads may be displayed based upon the advertiser's predefined criteria and the best matching algorithm described in FIG. 5. At 622, data will be collected and maintained as to the times ads are displayed, the areas covered, and the target population reached by the ads. If at 624 the desired impressions are not achieved, the advertiser may readjust parameters at 614. If the results are acceptable, at 626 the ad campaign may continue until either the budget runs out or the time expires. At 628, payments may be calculated for vehicle owners based upon the areas traversed, the times of day, and the driving times in each area. The data produced by process 600 may be stored in the database 122 of the web portal.

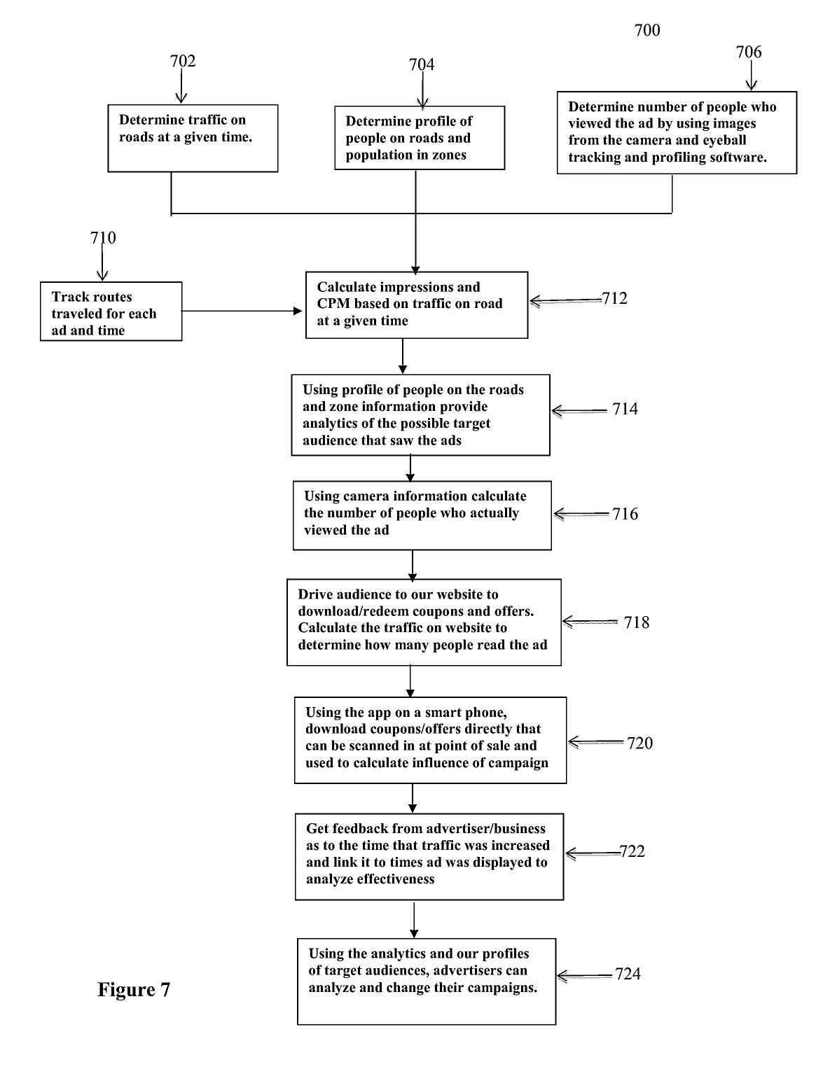

FIG. 7 illustrates an analytics process 700 which may be embodied in analytics module 124 of the web portal. The data input to the process may comprise the traffic on the roads at a given time (702), the profiles of the people of the roads and the population in zones (704) and the number of people who viewed an ad by using images from the camera 208 of the vehicle display module to track the eyes of the people behind the display to determine whether they are viewing the display, and by using a profiling process to determine the profiles of the viewers.

At 712, an estimate may be made of the impressions created by an ad based upon the traffic on a road at a given time. At 714 using the profiles of the people on the roads and the zone information an estimate can be made of the possible target audience that saw the ads. At 716, the camera information can be used to determine the number of people who actually viewed an ad, and at 720 the number of coupons or offers downloaded from an advertiser's website, or used for purchases, may be used as measures of the influence of an ad campaign. Feedback may also be obtained from advertisers as to the times traffic to their website was increased, and used to analyze effectiveness of the campaign at 722. At 724, based upon the analytics provided advertisers to determine the impact of their advertising campaigns and change the campaigns as appropriate.

From the foregoing, it will be appreciated that the invention affords an effective targeted dynamic advertising system and method that allows advertisers to optimize their advertising campaigns in real-time based upon changing conditions and factors, while providing analytical information that allows advertisers to measure the effectiveness of their campaigns and to plan future ad campaigns.

Although the foregoing has been with respect to preferred embodiments, it will be appreciated that changes to these embodiments may be made without departing from the principles and spirit of the invention, the scope of which is defined by the appended claims.

1. A system for displaying content from a vehicle, comprising:
a display panel mountable to an interior of a window of the vehicle for displaying said content;
a microcontroller for controlling said display panel to display said content;
a GPS module for measuring real-time geographic position of the vehicle; and
a wireless communications module for receiving from a remote site said content for display, said content dynamically changing in response to said vehicle geographic position and predetermined criteria.

2. The system of claim 1, wherein said wireless communications module communicates said real-time geographic position information to said remote site.

3. The system of claim 1 further comprising a camera positionable in said vehicle window to view others outside of the vehicle.

4. The system of claim 3, wherein said remote site comprises a web portal for receiving wireless communications of real time vehicle geographic position and information from said camera about others behind the vehicle.

5. The system of claim 4, wherein said web portal said comprises a content selecting module for selecting content for display on said display panel in response to said real time vehicle geographic position and said predetermined criteria, and wirelessly communicates said content to the communications module for display.

6. A system for displaying content on a display panel at an interior of a window of a vehicle, comprising:
a web portal for communicating said content wirelessly to said vehicle for display on said display panel, the web portal having a content selection module for dynamically changing the content communicated to said vehicle in response to vehicle geographic position and predetermined criteria.

7. The system of claim 6, wherein said content comprises an advertisement, and said predetermined criteria comprises real time criteria established by an advertiser for advertisement selection.

8. The system of claim 7, wherein said real time criteria comprises one or more of vehicle location, speed, direction of travel, time, vehicle type, number of vehicle displays available, and profile of a population in the vicinity of the vehicle.

9. The system of claim 7, wherein said content matching module executes a process for optimizing advertisement selection for display based upon said real time criteria.

10. The system of claim 9, wherein said process for optimizing advertisement selection executes an analytical process to select advertisements for display based upon evaluation of real time conditions.

11. The system of claim 7, where said web portal provides an interface for an advertiser to input said advertisements and said predetermined criteria.

12. The system of claim 11, wherein said web portal provides pricing information to said advertiser for advertisements based upon the predetermined criteria.

13. The system of claim 12, wherein said web portal provides information to an owner of said vehicle of revenue earned for advertisements displayed by said vehicle.

14. The system of claim 7, wherein said web portal provides an interface for viewers of displayed advertisements to review said displayed advertisements based upon one or more of time and location of display in said vehicle.

15. A method of displaying content from a vehicle, comprising:
measuring in real time geographic position of the vehicle;
displaying content on a display panel within the vehicle positioned such that the content is visible to others outside of the vehicle, said displaying comprising dynamically changing said displayed content in response to said vehicle geographic position and in response to predetermined criteria.

16. The method of claim 15 further comprising communicating wirelessly in real time said vehicle geographic position to a remote site, and receiving wirelessly at the vehicle content communicated from said remote site.

17. The method of claim 15, wherein said content comprises an advertisement, said predetermined criteria being established by an advertiser and comprising one or more of vehicle location, speed, direction of travel, time, and profile of a population in the vicinity of the vehicle.

18. The method of claim 17, wherein said display panel is positioned at a rear window of the vehicle so as to be visible from behind the vehicle, and the method further comprises determining in real time profile information as to those viewing said advertisement.

19. The method of claim 18, wherein said determining comprises capturing images of viewers in the vicinity of the vehicle, and determining from eyes of said viewers a number of viewers observing the advertisement and the length of time said viewers observe said advertisement.

20. The method of claim 19 further comprising analyzing the effectiveness of an advertisement from actions taken by viewers in response to the advertisement.

21. The method of claim 20, wherein said remote site comprises a web portal, and said analyzing comprises measuring at said web portal viewer actions related to said advertisement.

22. The method of claim 21, wherein said analyzing comprises estimating the impressions on viewers of an advertisement using one or more of traffic on a road at a time where the advertisement was displayed, profile of audience in zone where the advertisement was displayed, images of viewers who saw the advertisement, and viewer interaction with the web portal.

23. The method of claim 20 further comprising adjusting the predetermined criteria in real time based upon one or more of the effectiveness of an advertisement and costs.

24. The method of claim 17 further comprising optimizing selection of advertisements for display based upon real time conditions and said predetermined criteria.

25. The method of claim 24, wherein there are a plurality of vehicle displays, and said optimizing comprises selecting different advertisements for said plurality of displays to optimize cost and time of display for each advertisement.

26. The method of claim 25, wherein said selecting different advertisements comprises selecting advertisements based upon an auction among advertisers.
